(19) United States
(12) Patent Application Publication
(10) Pub. No.: US 2012/0116623 A1
(43) Pub. Date: May 10, 2012

(54) Method and device for operating a vehicle, in particular a hybrid vehicle

(76) Inventors: Alexander Maass, Ludwigsburg (DE); Manfred Hellmann, Hardthof (DE)

(21) Appl. No.: 13/265,687

(22) PCT Filed: Feb. 23, 2010
(86) PCT No.: PCT/EP2010/052292

§ 371 Date: Jan. 6, 2012

(30) Foreign Application Priority Data
Apr. 23, 2009 (DE) 10 2009 002 586.3

(51) Int. Cl. B60W 20/00; B60W 10/08; B60W 10/06

(52) U.S. Cl. 701/22; 903/930

(57) ABSTRACT

A method is described for operating a vehicle, in particular a hybrid vehicle, in which at least one of the axles of the vehicle is driven by a drive unit causing the vehicle to be accelerated at a predefined setpoint torque, in that a partial drive torque is transferred to at least one axle and the wheels coupled to it. For the setpoint torque requested by the driver to be converted into the corresponding acceleration of the vehicle, the partial drive torque of the steered axle and/or the unsteered axle is corrected while negotiating a curve in such a way that the vehicle is accelerated at the predefined setpoint torque.

### FIELD OF THE INVENTION

The present invention relates to a method for operating a vehicle, in particular a hybrid vehicle, at least one of the axles of the vehicle being driven by a drive unit causing the vehicle to be accelerated at a predefined setpoint torque, in that a partial drive torque is transferred to at least one axle and the wheels coupled to it as well as a device for implementing the method.

### BACKGROUND INFORMATION

A generic device is discussed in DE 35 42 059 C1. In the discussed manner, the vehicle has a main drive axle capable of being driven by an internal combustion engine. In the case of increased slip of the wheels of the main drive axle, the wheels of an engageable supplemental drive axle may be driven automatically using a separate supplemental drive unit, in particular an electric motor.

In this connection, a setpoint torque of the vehicle, which is set, for example, by a driver by operating an accelerator pedal in the vehicle, is distributed to the two axles of the vehicle. When negotiating curves where the steering of the vehicle is turned, the effect occurs that the torque acting on the steered wheels contributes more to the acceleration of the vehicle than the torque acting on the unsteered wheels. In the case that high, counteracting torques are present on both axles, only a change of the steering angle would undesirably change the setpoint torque of the vehicle. This would be unpleasantly noticeable for the driver.

### SUMMARY OF THE INVENTION

A method for operating a vehicle having the features described herein has the advantage that the set setpoint torque is actually implemented by the vehicle's driving behavior even when negotiating curves. Due to the fact that, when negotiating a curve, the partial drive torque of the steered and/or unsteered axle is corrected in such a way that the vehicle is accelerated at the predefined setpoint torque, the different lever relationships of the wheels of the steered and the unsteered axle are compensated.

Advantageously, the partial drive torque of the steered and/or the unsteered axle is corrected as a function of a distance of the wheels to the center of rotation of the vehicle. When negotiating a curve as a result of the turned steering, the different lengths of the lever arms of the wheels to the center of rotation of the vehicle at an equal wheel torque cause an acceleration impact of varying strength on the vehicle, which results in a different effect on the vehicle's steered and unsteered axle and accordingly a differentiated acceleration behavior of the vehicle. This differentiated acceleration behavior is compensated reliably.

In one embodiment, the partial drive torque of the steered and/or the unsteered axle is corrected as a function of a steering angle of the wheels of the steered axle. The described compensation is usable both for hybrid drives and also in all-wheel drives and conventional drives.

Advantageously, the predefined setpoint torque is determined and broken down into partial drive torques of the steered and the unsteered axle, at least one partial drive torque being corrected as a function of the steering angle of the wheels of the steered axle and the partial drive torques subsequently being transferred to the steered and the unsteered axle. Since the setpoint torque is distributable in any manner between the steered and unsteered axle, the compensation always takes place consistent with the drive request made by the driver. In this connection, the steered and the unsteered axle and accordingly the wheels may be driven both positively and negatively.

In one embodiment, the partial drive torques are distributed to the wheels of the steered and unsteered axle as a function of an operating state of the vehicle. The partial drive torques may thus be distributed to the steered and the unsteered axle as a function of a charge of battery. For example, when an electric motor is used as a drive unit, the electric motor operated by the battery may be used for driving the one axle when the battery is at a full charge, while the battery may be charged by a drive unit driving the other axle, for example, an internal combustion engine, when the charge is low.

In one refinement, the correction of the partial drive torques is made as a function of a reference point which refers to the steered or the unsteered axle or to a position between the steered and the unsteered axle. The result is that the axle selected as the reference point is regarded as a correctly set axle. As a function of this reference point, the drive torques of the other axles are then corrected as a function of the drive through a curve.

Advantageously, the unsteered axle is determined as the reference point for the predefined setpoint torque, the partial drive torque of the steered axle being reduced as a function of the steering angle of the wheels of the steered axle after the distribution of the drive torques. This process minimizes the required computational power of the system, since the relationships between the predefined setpoint torque, the steering angle and the corrected partial drive torques may be read out simply from a table or a characteristic curve.

In one embodiment, the steered axle is selected as the reference point for the predefined setpoint torque, the partial drive torque of the unsteered axle being increased as a function of the steering angle of the steered wheels. This causes the driving torques on both axles to be compensated.

Advantageously, a position between the steered and the unsteered axle is selected as the reference point for the predefined setpoint torque, the partial drive torque on the steered axle being reduced and the partial drive torque on the unsteered axle being increased.

In another refinement, the exemplary embodiments and/or exemplary methods of the present invention relates to a device for operating a vehicle, in particular a hybrid vehicle, in which at least one of the axles of the vehicle is driven by a drive unit causing the vehicle to be accelerated at a predefined setpoint torque, in that a partial drive torque is transferred to at least one axle and the wheels coupled to it.

In order to always set the setpoint torque of the vehicle in such a way that it consistently agrees with the driver's request, a correcting arrangement is provided which, when negotiating a curve, correct the partial drive torque of the steered and/or the unsteered axle in such a way that the vehicle is accelerated at the predefined setpoint torque. As a result, the set setpoint torque is actually implemented by the vehicle's driving behavior when negotiating curves. This reliably prevents a maloperation of the vehicle due to a difference in the strength of forces acting on the wheels of the steered and the unsteered axle.

In one embodiment, the correcting arrangement corrects the partial drive torque of the steered and/or the unsteered axle as a function of a distance of the wheels to the center of rotation of the vehicle.

Advantageously, a control unit determines the predefined setpoint torque and divides it into partial drive torques of the steered and the unsteered axle, the partial drive torques being corrected as a function of an angle of the wheels of the steered axle, and the partial drive torques subsequently being transferred to the steered and the unsteered axle. The wheel torques of the wheels of the unsteered and/or the steered axle are corrected and set according to the calculations of the control unit. Correcting the wheel torques causes the requested acceleration or deceleration of the vehicle to be achieved.

In one embodiment, the control unit is connected to a first drive unit for activating the steered axle and a second drive unit for activating the unsteered axle. This makes it possible to set the partial drive torques which are transferred from the drive units to the particular wheels of the axles in a simple way.

In one refinement, the first drive unit is designed as an internal combustion engine and the second drive unit is designed as an electric motor. In the case of such axle hybrid vehicles in particular, a different acceleration effect of the front and rear wheels of the vehicle is reliably prevented when the steering is turned.

Numerous specific embodiments are allowed according to the present invention and will be elucidated in greater detail with reference to the figures in the drawings.

### BRIEF DESCRIPTION OF THE DRAWINGS

FIG. 1 shows an exemplary embodiment of a device according to the present invention for the drive of mechanically uncoupled axles.

FIG. 2 shows lever relationships on the vehicle wheels while negotiating a curve.

FIG. 3 shows a schematic flow chart of a method according to the present invention for operating the device according to FIG. 1.

### DETAILED DESCRIPTION

Identical features are denoted by identical reference numerals.

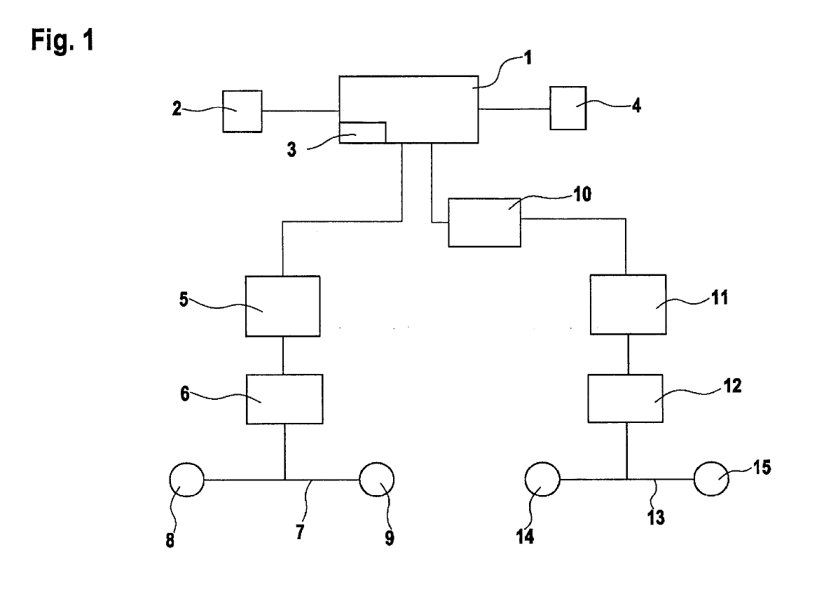

FIG. 1 shows an engine control unit 1 which is supplied with an intended drive torque as the setpoint torque. The driver inputs this setpoint torque in engine control unit 1 by setting accelerator pedal 2. However, it is also possible for the input to be provided by a driver assistance system (not represented in greater detail) or a vehicle dynamics control system of the vehicle (also not shown) or an automatic transmission.

Engine control unit 1 has a memory 3, in which characteristic curves and tables are stored, which are necessary for the control and regulation of the vehicle's drive.

Furthermore, engine control unit 1 is connected to a steering angle sensor 4 which detects the steering angle selected by the driver. Moreover, engine control unit 1 is connected directly to internal combustion engine 5 which drives a first axle 7 via a first gear unit 6, both drive wheels 8, 9 being situated on first axle 7. First axle 7 is a steered axle, which means that the steering movements performed by the driver on the steering wheel are transferred to front wheels 8, 9 of the vehicle.

Engine control unit 1 is furthermore connected to an electric motor control unit 10 which activates an electric motor 11. Electric motor 11 is connected via a second gear unit 12 to a second, unsteered axle 13 of the vehicle which drives rear wheels 14 and 15 of the vehicle.

When the vehicle is driven straight ahead, the setpoint torque input by the driver is distributed to steered axle 7 and unsteered axle 13, so that the sum of the wheel torques of wheels 8, 9; 14, 15 is equal to the setpoint torque. When negotiating curves, this constellation changes.

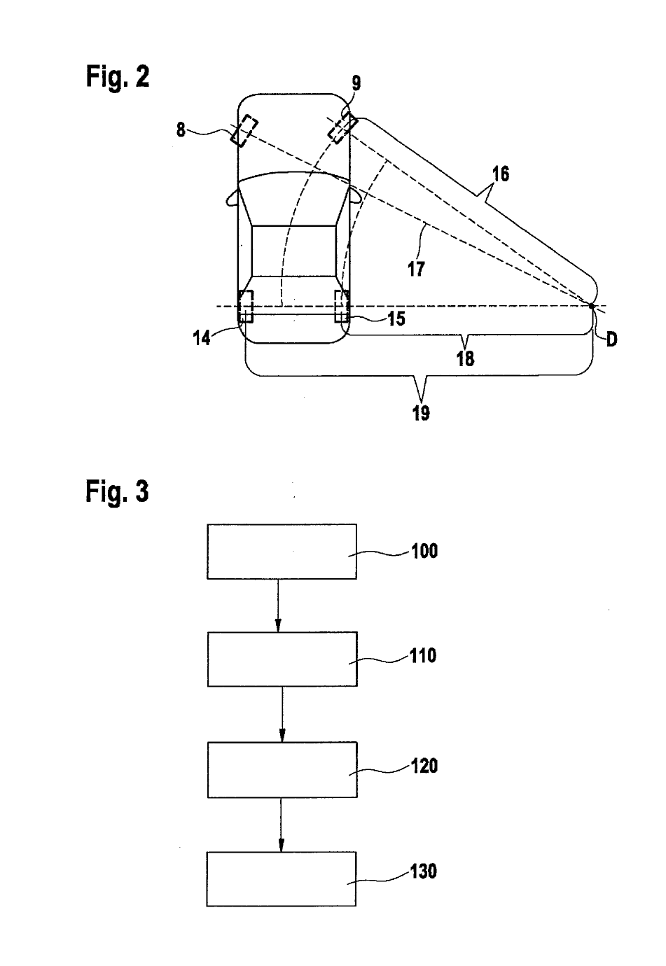

FIG. 2 shows center of rotation D of the vehicle while the steering is turned. It is apparent that front wheels 8, 9 have longer lever arms 16, 17 than lever arms 18, 19 of rear wheels 14, 15 of the vehicle.

Longer lever arms 16, 17 of steered axle 7 cause front wheels 8, 9 of the vehicle to be accelerated faster than rear wheels 14, 15 at an identical torque. It is possible for this difference to amount to approximately 30% when front wheels 8, 9 are fully turned. This means that a torque of, for example, 100 Nm on unsteered axle 13 accelerates the vehicle as quickly as front wheels 8, 9 of steered axle 7 when a torque of 70 Nm acts on it.

In the case of an axle hybrid as represented in FIG. 1, the result of this is that steered axle 7 is driven by internal combustion engine 5 at +50 Nm when the accelerator pedal position is kept constant (setpoint torque=const.). Unsteered axle 13 is decelerated by electric motor 11 acting as a generator at −60 Nm; when driving straight ahead, a decelerating torque totaling −10 Nm is active.

If the driver now turns front wheels 8, 9 fully and the compensation described according to the exemplary embodiments and/or exemplary methods of the present invention is not used, the sum derived from the axle torque of steered axle 7 and the axle torque of unsteered axle 13 remains at −10 Nm. However, since wheels 8, 9 of steered axle 7 have, as explained, a significantly longer lever arm 16, 17, the vehicle is abruptly accelerated if the accelerator pedal position is unchanged.

If engine control unit 5 switches internal combustion engine 5 off while negotiating curves, the −10 Nm requested by the driver is delivered exclusively by the wheels of unsteered axle 13, causing the vehicle to be decelerated abruptly again.

The method prevents such effects, which will be explained in greater detail below with reference to FIG. 3. For the sake of simplicity, instead of the wheel torques of the individual wheels, consideration in this case will only be given to the partial drive torques of steered axle 7 and unsteered axle 13, which connect front wheels 8, 9 and rear wheels 14, 15 of the vehicle.

In block 100, engine control unit 1 detects the input of a setpoint torque which is divided into partial drive torques and distributed to the front and rear axle, for example as a function of a charge state of a high voltage battery which drives electric motor 11. The steering angle is detected in block 110.

In block 120, the partial drive torque of unsteered axle 13 is considered to be correct. The partial drive torque of steered axle 7 is reduced by a factor of 1 as a function of the measured steering angle. In a particularly simple embodiment, the factor is determined from the cosine of the steering angle of the wheels on the steered axle.

Alternatively, the setpoint torque will be based on a point between axles 7, 13. The reference point may, for example, lie on the front seat bench in the area of the driver seat, which improves the sense of acceleration for the driver. The partial drive torque on unsteered axle 13 is increased as a function of the steering angle, while the partial drive torque on the unsteered axle is reduced as a function of the steering angle.

In block 130, the partial drive torques determined in block 120 are output to steered axle 7 and unsteered axle 13.

1-14. (canceled)

15. A method for operating a vehicle, which is a hybrid vehicle, in which at least one of the axles of the vehicle is driven by a drive unit and causes the vehicle to be accelerated at a predefined setpoint torque, in that a partial drive torque is transferred to at least one of the axles and the wheels coupled to it, the method comprising:
correcting, while negotiating a curve, the partial drive torque of at least one of a steered axle and an unsteered axle so that the vehicle is accelerated at the predefined setpoint torque.

16. The method of claim 15, wherein the partial drive torque of the at least one of the steered axle and the unsteered axle is corrected as a function of a distance of the wheels to a center of rotation of the vehicle.

17. The method of claim 15, wherein the partial drive torque of the at least one of the steered axle and the unsteered axle is corrected as a function of a steering angle of the wheels of the steered axle.

18. The method of claim 15, wherein the predefined setpoint torque is determined and divided into partial drive torques of the steered axle and the unsteered axle, wherein at least one partial drive torque is corrected as a function of a steering angle of the wheels of the steered axle, and wherein the ascertained partial drive torques subsequently being transferred to the steered axle and the unsteered axle.

19. The method of claim 18, wherein the partial drive torques are distributed to the steered axle and the unsteered axle as a function of an operating state of the vehicle.

20. The method of claim 15, wherein the correction of the partial drive torques is made as a function a reference point which is based on (i) one of the steered axle and the unsteered axle and (ii) a position between the steered axle and the unsteered axle.

21. The method of claim 20, wherein the unsteered axle is determined as the reference point for the predefined setpoint torque, and wherein the partial drive torque of the steered axle is corrected as a function of the steering angle of the wheels of the steered axle.

22. The method of claim 20, wherein the steered axle is selected as the reference point for the predefined setpoint torque, and wherein the amount of the partial drive torque of the unsteered axle is increased as a function of the wheel deflection.

23. The method of claim 20, wherein a position between the steered axle and the unsteered axle is selected as the reference point for the predefined setpoint torque, and wherein the amount of the partial drive torque on the steered axle is reduced and the amount of the partial drive torque on the unsteered axle is increased.

24. A device for operating a vehicle, which is a hybrid vehicle, in which at least one of the axles of the vehicle is driven by a drive unit and causes the vehicle to be accelerated at a predefined setpoint torque, in that a partial drive torque is transferred to at least one axle and the wheels coupled to it, comprising:
a correcting arrangement to, while negotiating a curve, correct the partial drive torque of the at least one of the steered axle and the unsteered axle so that the vehicle is accelerated at the predefined setpoint torque.

25. The device of claim 24, wherein the correcting arrangement corrects the partial drive torque of the at least one of the steered axle and the unsteered axle as a function of a distance of the wheels to the center of rotation of the vehicle.

26. The device of claim 24, further comprising:
a control unit to determine the predefined setpoint torque and break it down into partial drive torques of the steered axle and the unsteered axle;
wherein the partial drive torques are corrected as a function of a steering angle of at least one of the wheels of the steered axle and transferred to the steered axle and the unsteered axle.

27. The device of claim 26, wherein the control unit is connected to a first drive unit for activating the steered axle and to a second drive unit for activating the unsteered axle.

28. The device of claim 27, wherein the first drive unit is configured as an internal combustion engine and the second drive unit is configured as an electric motor.
